(19) United States
(12) Patent Application Publication
(10) Pub. No.: US 2014/0089830 A1
(43) Pub. Date: Mar. 27, 2014

(54) VISIBLE SORT

(71) Applicant: APPLE INC., Cupertino, CA (US)

(72) Inventors: Heather L. Winkle, Cupertino, CA (US); Ashok Srinivasan, Ottawa (CA)

(73) Assignee: Apple Inc., Cupertino, CA (US)

(21) Appl. No.: 13/626,615

(22) Filed: Sep. 25, 2012

(51) Int. Cl. G06F 3/048

(52) U.S. Cl. 715/769; 715/810

(57) ABSTRACT

A system can provide for display a ribbon having multiple segments for controlling how data in a table are sorted. The data can be sorted according to a sort hierarchy including multiple sort levels, each sort level corresponding to a field. Each segment in the ribbon can correspond to a field in the table. A position of a segment in the ribbon can represent a sort level of the corresponding field. An order of the segments in the ribbon can represent the sort hierarchy for the table. The system can receive a user input rearranging the segments in the ribbon. When the order of the segments in the ribbon changes according to the rearrangement, the system can change the sort hierarchy of the table.

### TECHNICAL FIELD

This disclosure relates generally to database applications.

### BACKGROUND

A modern database tool can integrate a database engine with a graphical user interface (GUI). Content of the database can be formatted and displayed in the GUI in a variety of ways according to a design of a builder of the database. The records in a current found set may be sorted according to one or more fields. A conventional GUI presents a dialog box for the user to select one or more of these fields, specify the order relative to one another, and the order within the field data. For example, a table “employees” can have fields including employee number, employee first name, and employee last name. Data can be sorted on a first sort level by employee last name, and then, if two employees have the same last name, records for the two employees can be sorted on a second sort level by employee first name. If the two employees also have the same first name, the records for the two employees can then be sorted on a third sort level by employee number.

### SUMMARY

Methods, program products, and systems for visible sort are described. A system can provide for display a user interface item (e.g., a ribbon) having multiple segments for controlling how data are sorted. The data can be sorted according to a sort hierarchy including multiple sort levels, each sort level corresponding to a field. Each segment in the user interface item can correspond to a field. A position of a segment in the user interface item can represent a sort level of the corresponding field. An order of the segments in the user interface item can represent the sort hierarchy for the records being displayed. The system can receive a user input rearranging the segments in the user interface item. When the order of the segments in the user interface item changes according to the rearrangement, the system can change the sort hierarchy of the records.

Visible sort can be implemented to achieve the following advantages. Compared to a conventional system, visible sort can provide a user interface that indicates the current sort order. Visible sort can provide a user interface that reduces number of operations a user needs to perform to create or modify a sort hierarchy. Visible sort can allow a user to change the sort hierarchy by drag and drop, without using a dialog box. Accordingly, usability of a system implementing visible sort is improved over a conventional database application system.

The details of one or more implementations of visible sort are set forth in the accompanying drawings and the description below. Other features, aspects, and advantages of visible sort will become apparent from the description, the drawings, and the claims.

### BRIEF DESCRIPTION OF THE DRAWINGS

FIG. 1 illustrates an exemplary user interface for visible sort.

FIG. 2 illustrates an exemplary user interface for configuring a sort level in a sort hierarchy.

FIG. 3 illustrates an exemplary user interface for modifying a sort hierarchy.

FIG. 4 is a block diagram of an exemplary system implementing visible sort.

FIG. 5 is flowchart illustrating an exemplary process of modifying sort hierarchy.

FIG. 6 is a block diagram of an exemplary system architecture for implementing the features and operations of FIGS. 1-5.

Like reference symbols in the various drawings indicate like elements.

### DETAILED DESCRIPTION

### Overview

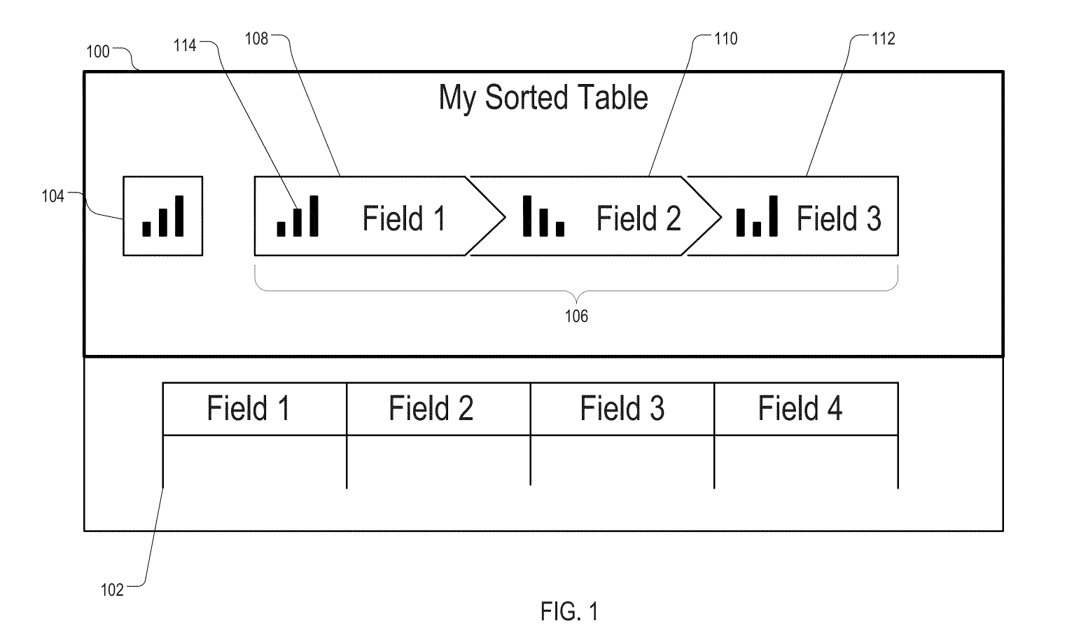

FIG. 1 illustrates exemplary user interface 100 for visible sort. In the example shown, visible sort can be implemented in a system executing a database application program. The system can provide a data set 102 for display in user interface 100. The data set 102 can include data retrieved from a database. The data in the data set 102 can have multiple data records. Each data record can be a set of fields that relate to an entity or event, e.g., an activity, an individual, a subject, or a transaction. A field can be a unit of data. The unit of data can hold data in a specific, discrete category, e.g., last name, employee number, or employee photo. In addition, a field can display a result of a calculation. A field can have a field type, which can be, for example, text, number, date, time, timestamp, container, calculation, or summary. The data set 102 can be sorted according to a sort hierarchy. The sort hierarchy can specify one or more sort levels, e.g., a first sort level, a second sort level, and a third sort level. Each sort level can correspond to a field (e.g., field 1, field 2, or field 3). Records of the data set 102 can be sorted in order of the sort levels specified in the sort hierarchy, e.g., at the first sort level by field 1; then, to break ties in the first sort level, at the second sort level by field 2; and then, to break ties in the second sort level, at the third sort level by field 3.

The system can provide for display a visible sort control 104. The visible sort control 104 can be a user interface item that, upon activation, causes the system to sort according to a sort order previously set up via sort dialog. Control 104 may be toggled on or off to sort or unsort the data according to the specified sort. The system can provide for display a visible sort user interface item, e.g., visible sort ribbon 106. The visible sort ribbon 106 can indicate the sort hierarchy of the data set 102 and be used to re configure the sort hierarchy of the data set 102.

The visible sort ribbon 106 can include ribbon segments 108, 110, and 112. Each of the ribbon segments 108, 110, and 112 can correspond to a sort level in the sort hierarchy of data set 102. The ribbon segments 108, 110, and 112 can be arranged in an order that reflects the relationship between sort levels in the sort hierarchy of the data set 102. For example, the ribbon segment 108, when displayed at a left-most position in the visible sort ribbon 106, can correspond to a top sort level (e.g., the first sort level) in the sort hierarchy. The ribbon segment 110, when displayed at a middle position in the visible sort ribbon 106, can correspond to a middle sort level (e.g., the second sort level) in the sort hierarchy. The ribbon segment 112, when displayed at a right-most position in the visible sort ribbon 106, can correspond to a bottom sort level (e.g., the third sort level) in the sort level in the sort hierarchy.

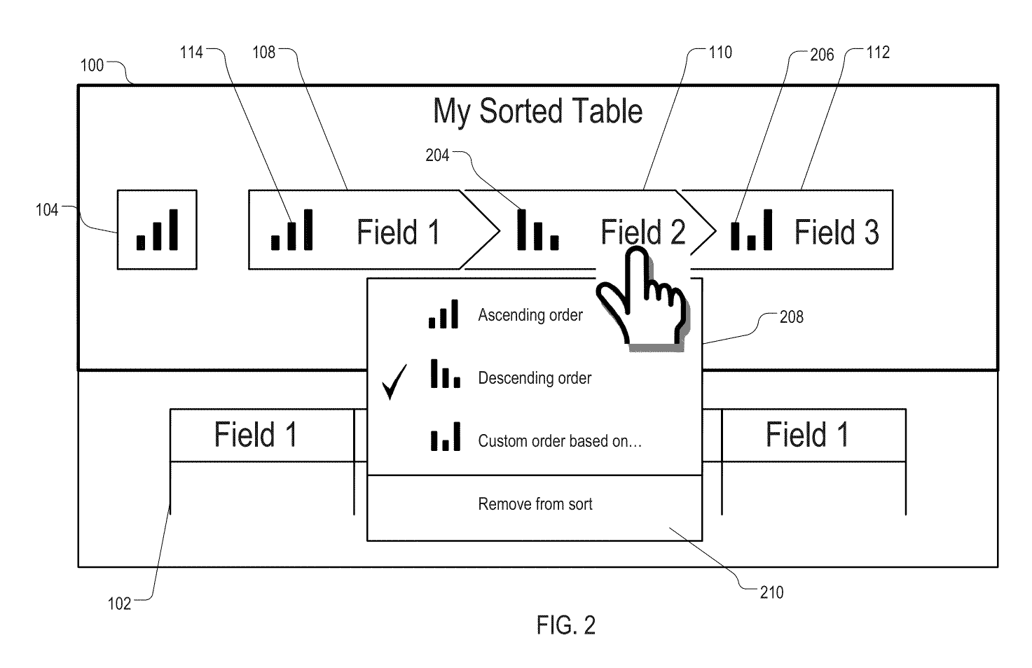

Each of the ribbon segments 108, 110, and 112 can have at least one wedge-shaped end having an appearance that the ribbon segment is interlocked with another ribbon segment to form the visible sort ribbon 106. Each of the ribbon segments 108, 110, and 112 can display an identifier of a field at the corresponding sort level. The identifier can be a field name or a label associated with the field. For example, ribbon segment 108 can display field name “Field 1” of field 1, by which the data set 102 is sorted at the first sort level. The ribbon segment 110 can display field name “Field 2” of field 2, by which data set 102 is sorted at the second sort level. The ribbon segment 112 can display field name “Field 3” of field 3, by which data set 102 is sorted at the third sort level. Each of ribbon segments 108, 110, and 112 can display a sort order indicator, e.g., sort order indicator 114, indicating how the table is sorted at the corresponding sort level. Additional details of the sort order indicator will be described below in reference to FIG. 2.

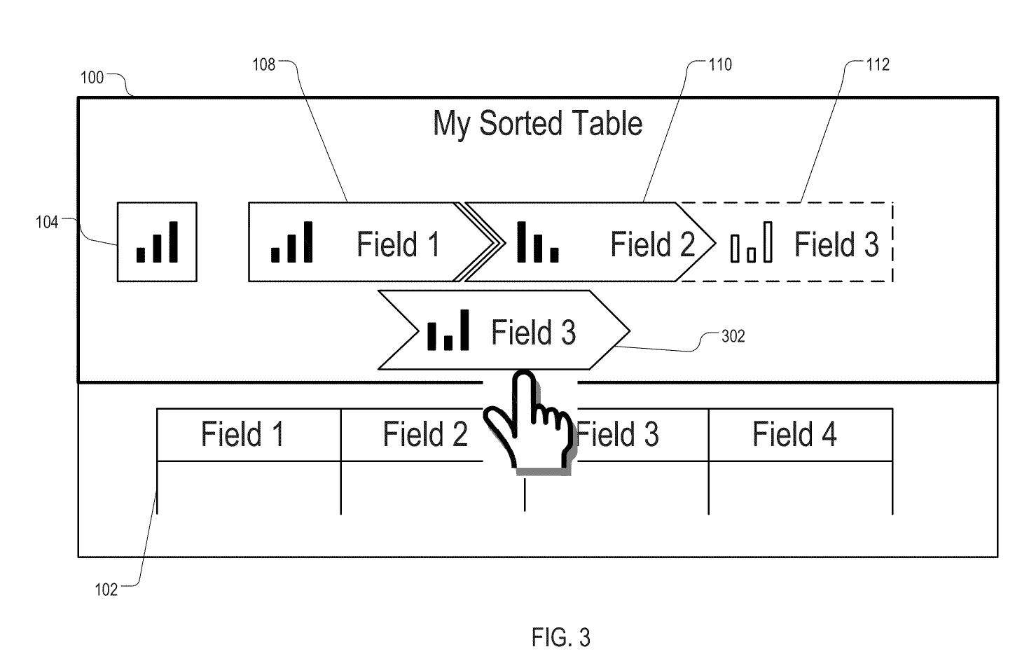

The system can change relative positions of ribbon segments 108, 110, and 112 in response to a user input. If the relative position changes, the underlying sort hierarchy can change accordingly. Additional details of changing the sort hierarchy will be described below in reference to FIG. 3.

In response to a user input, the system can add a ribbon segment to the visible sort ribbon 106 or remove a ribbon segment from the visible sort ribbon 106. Adding a new ribbon segment in the visible sort ribbon 106 can cause a new sort level to be created in the sort hierarchy of the data set 102. A position of the new sort level in the sort hierarchy can correspond to the position of the new ribbon segment in the visible sort ribbon 106. Removing a ribbon segment from the visible sort ribbon 106 can cause a corresponding sort level to be removed from the sort hierarchy of the data set 102. In addition, if the sort hierarchy of the data set 102 changes (e.g., based on input received from a conventional sort configuration interface outside of the visible sort ribbon 106), the visible sort ribbon 106 can change accordingly.

The visible sort ribbon 106 is illustrated as a horizontal ribbon, where a left-most ribbon segment corresponds to a top sort level in the sort hierarchy. Other representations are possible. For example, the visible sort ribbon 106 can be displayed vertically, where a top segment corresponds to the top sort level in the sort hierarchy. The visible sort control 104 can toggle the visible sort ribbon 106 on and off.

The data set 102 of FIG. 1 is shown as a table having columns corresponding to fields. The table can have rows corresponding to data records. In a table view, multiple rows can be displayed. Visible sort can be applied to data set 102 when data set 102 is displayed in other formats. For example, the visible sort ribbon 106 can be displayed with data set 102 when data set 102 is displayed in a form view, in which one data record is displayed each time. In addition, the visible sort ribbon 106 can be displayed with data set 102 when data set 102 is displayed in a list view, in which one data record is displayed each time as a list.

### Configuring a Sort Level

FIG. 2 illustrates exemplary user interface 200 for configuring a sort level in a sort hierarchy. At each sort level, records of a data set (e.g., a table) can be sorted by a field in a sort order that includes one of an ascending order, a descending order, or a custom order. Each of ribbon segments 108, 110, and 112 can have a sort order indicator indicating which sort order is applied at the corresponding sort level.

For example, the ribbon segment 108 can have a sort order indicator 114. The sort order indicator 114 can include multiple bars each having a distinct length. The multiple bars can be arranged in ascending order according to their respective lengths. The arrangement of the sort order indicator 114 can indicate that the sort order at the sort level represented by the ribbon segment 108 is an ascending sort order.

The ribbon segment 110 can have a sort order indicator 204. Sort order indicator 204 can include multiple bars each having a distinct length. The multiple bars can be arranged in descending order according to their respective lengths. The arrangement of the sort order indicator 204 can indicate that the sort order at the sort level represented by the ribbon segment 110 is a descending sort order.

The ribbon segment 112 can have a sort order indicator 206. The sort order indicator 206 can include multiple bars each having a distinct length. The multiple bars can be arranged in neither an ascending order nor a descending order according to their respective lengths. The arrangement of the sort order indicator 206 can indicate that the sort order at the sort level represented by the ribbon segment 112 is a custom sort order.

The sort order in each of the ribbon segments 108, 110, and 112 can be individually configured. The configuration can determine a sort order in the sort hierarchy of data set 102. For example, the system providing the visible sort ribbon 106 can receive a select input on the ribbon segment 110. The select input can include a mouse click when a cursor is hovering on the ribbon segment 110, a touch input on the ribbon segment 110 from a touch-sensitive surface, or a voice input (e.g., “select the second segment on the visible sort ribbon”). When the ribbon segment 110 is selected, the system can cause the ribbon segment 110 to be emphasized (e.g., highlighted) when the cursor is hovering on the ribbon segment 110.

When the system receives the select input, the system can provide for display a sort configuration box 208. The sort configuration box 208 can be a user interface item for receiving user input for configuring a sort order. The sort configuration box 208 can include options for configuring the sort order at the corresponding sort level (in this example, the second sort level). The options provided for user selection can include an ascending order, a descending order, and a custom order. A current sort order (e.g., a descending sort order) of the corresponding sort level can be emphasized (e.g., by highlighting or by a checkmark).

If the system receives an input in the sort configuration box 208 selecting a sort order that is different from the current sort order, the emphasis can change to the selected sort order in the sort configuration box 208. The underlying sort order at the corresponding sort level can be changed to the new, selected sort order. For example, when the “custom order” is selected, the system can provide a user interface for specifying a custom order (e.g., an order based on a function of values in a corresponding field), highlight the custom order option, and sort the underlying data accordingly.

The sort configuration box 208 can include a remove option 210. If the system receives an input selecting the remove option 210, the system can remove the currently selected ribbon segment (e.g., ribbon segment 110) from visible sort ribbon 106, and remove the corresponding sort level from the sort hierarchy of data set 102.

### Changing a Sort Hierarchy

FIG. 3 illustrates an exemplary user interface 300 for modifying a sort hierarchy. In a visible sort ribbon 106, each ribbon segment is a movable ribbon segment and can be individually positioned. Accordingly, the visible sort ribbon 106 can be disassembled and reassembled in different orders. The change of position of a ribbon segment in visible sort ribbon 106 can indicate a change of sort level for a corresponding field.

For example, a system providing the visible sort ribbon 106 for display can receive a select input selecting a ribbon segment 112. The select input can be a drag input, for example, by a cursor or by a finger, stylus, or other touch input device. Upon receiving the select input, the system can disassemble visible sort ribbon 106, for example, by de-emphasizing the ribbon segment 112 (e.g., by graying out the ribbon segment 112) and providing for display a temporary ribbon segment 302. The temporary ribbon segment 302 can move in response to a drag input. The temporary ribbon segment 302 can include components of the ribbon segment 112, e.g., a sort order indicator and an identifier of a field corresponding to the ribbon segment 112. When being dragged, the temporary ribbon segment 302 can have two wedged ends when the temporary ribbon segment 302 is moved to a position that is approximately between ribbon segment 108 and ribbon segment 110, or one wedged end and one square end when the temporary ribbon segment 302 is moved to a position before (e.g., to the left of) the ribbon segment 108.

When the temporary ribbon segment 302 is moved to a position that is approximately between the ribbon segment 108 and ribbon segment 110, a wedged shape between the ribbon segment 108 and ribbon segment 110 can be emphasized, e.g., highlighted or displayed in color different from colors in other portions of visible sort ribbon 106. The emphasis can indicate that if the system receives a drop input, e.g., when a mouse button is released or when a touch input device is lifted off screen, the system will place the temporary ribbon segment 302 between the ribbon segment 108 and ribbon segment 110.

If the system receives the drop input, the system can automatically reassemble the visible sort ribbon 106. Reassembled visible sort ribbon 106 can include the ribbon segment 108, ribbon segment 302, and ribbon segment 110, in that order. The system can remove deemphasized ribbon segment 112 from display. The ribbon segment 302, now a part of the reassembled visible sort ribbon 106, can correspond to column 3 of data set 102, as ribbon segment 112 did. Accordingly, a sort hierarchy of the data set 102 can be changed. For example, before visible sort ribbon 106 was disassembled, the data set 102 is sorted at a first sort level by column 1, a second sort level by column 2, and then a third level by column 3. After visible sort ribbon 106 is reassembled, data set 102 is sorted at a first sort level by column 1, a second sort level by column 3, and then a third level by column 2. In reassembling visible sort ribbon 106, the system can change shape of ribbon segment 110 such that ribbon segment 110 has one square end and one wedged end.

### Exemplary Modules of Visible Sort

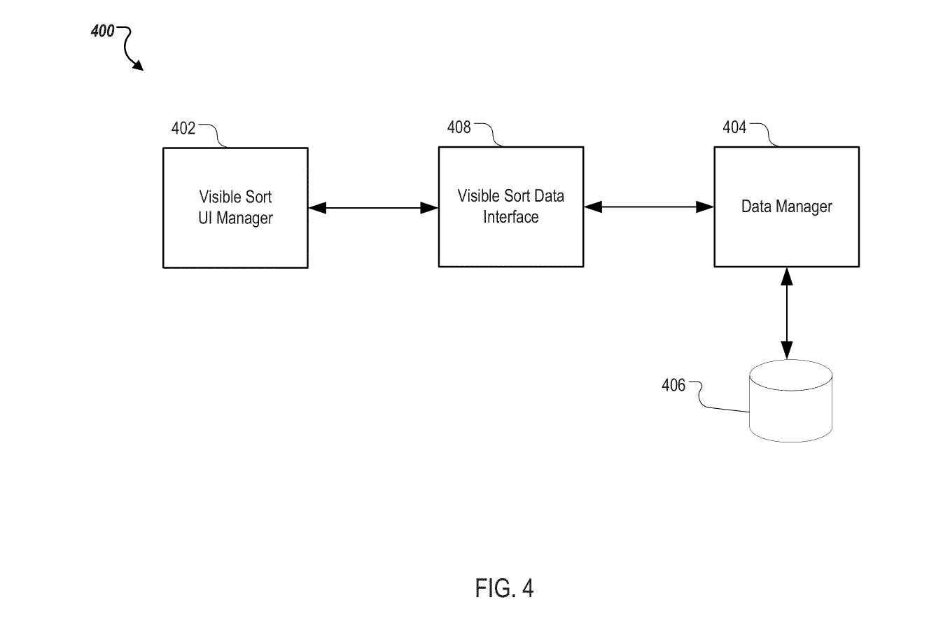

FIG. 4 is a block diagram of an exemplary system 400 implementing visible sort. System 400 can be the system as described above in reference to FIG. 1. System 400 can include a visible sort user interface manager 402. The visible sort user interface manager 402 can implement the features of drawing a visible sort ribbon 106, drawing sort configuration box 208, and rearranging (including disassembling and reassembling) ribbon segments of visible sort ribbon 106. Visible sort user interface manager 402 can receive user inputs from the drawn components, and redraw the components as requested by a user.

The system 400 can include a data manager 404. The data manager 404 can access data stored in data store 406, and format the data in a table format. Data manager 404 can perform the operations of sorting the data in multiple sort levels according to a sort hierarchy. When the sort hierarchy changes, e.g., when a sort level is added or removed, when an underlying field at a sort level is changed to another field, or when a sort order at a sort level has changed, data manager 404 can re-sort that data according to the changed sort hierarchy.

The system 400 can include a visible sort data interface 408. The visible data interface 408 can serve as an intermediary between data manager 404 and visible sort user interface manager 402. When the system 400 receives a request to display visible sort ribbon 106, visible sort data interface 408 can retrieve a sort hierarchy from data manager. The visible sort data interface 408 can then provide information on which sort level corresponds to which field to the visible sort user interface manager 402 to allow the visible sort user interface manager 402 to draw visible sort ribbon 106. When the visible sort user interface manager 402 receives a user input rearranging visible sort ribbon 106, the visible sort data interface 408 can submit the changes to data manager 404 to change the sort hierarchy.

### Exemplary Processes

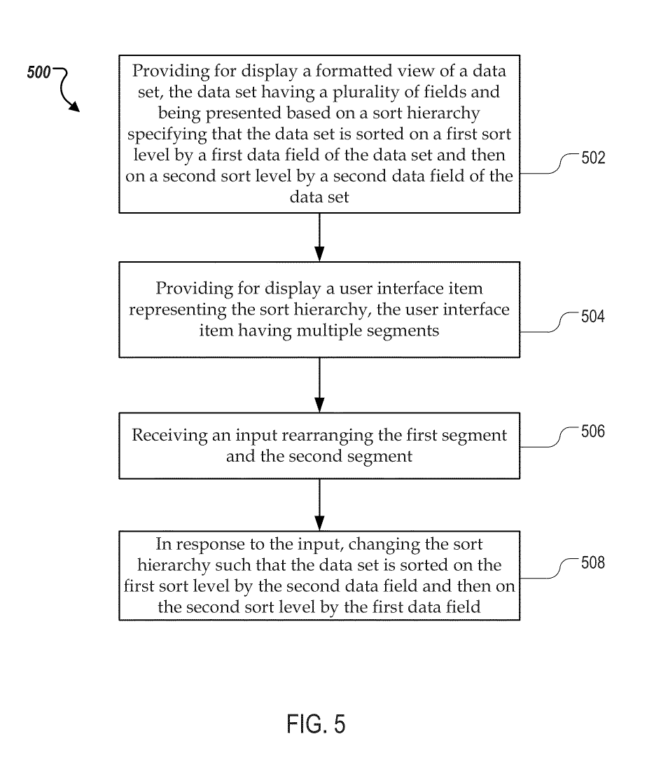

FIG. 5 is flowchart illustrating an exemplary process 500 of modifying sort hierarchy. Process 500 can be performed by a system as described above in reference to FIG. 4.

The system can provide (502) for display a formatted view of a data set. The data set can be formatted as a table having multiple fields. The data set can be presented based on a sort hierarchy. The sort hierarchy can specify that the data set is sorted on a first sort level by a first field of the data set and then on a second sort level by a second field of the data set to break a tie at the first sort level.

The system can provide (504) for display a user interface item representing the sort hierarchy. The user interface item can be a display item having multiple sections that can appear in a spatial sequence or order. For convenience, the user interface item will be described in reference to a ribbon, e.g., visible sort ribbon 106. The ribbon can have multiple segments (e.g., ribbon segments 108, 110, and 112). A first segment of the ribbon can correspond to a first sort level. A second segment can correspond to a second sort level. A display order of the first segment and the second segment in the ribbon can indicate the sort hierarchy. In some implementations, the ribbon can have a rectangular shape. Each segment of the ribbon can have at least one wedged end that appears locked with another segment. Each of the first segment and second segment can include an identifier (e.g., a column name) of a corresponding field and an indicator of a sort order. The sort order can be one of an ascending order, a descending order, or custom order in which the table is sorted on the corresponding field. The indicator of sort order can include a series of bars each having a length that is unique within the indicator. An arrangement of the bars can indicate that the corresponding sort order is the ascending order, the descending order, or the custom order.

In some implementations, the system can receive a select input on one of the first segment or second segment. In response to the select input, the system can provide for display a user interface (e.g., sort configuration box 208) for changing a sort order of the corresponding field or removing the corresponding segment from the ribbon.

The system can receive (506) an input rearranging the first segment and the second segment. The input can include selecting one of the first segment or second segment in the ribbon, and dragging and dropping the selected segment at a new position in the ribbon. Rearranging the first segment and the second segment can include disassembling and reassembling the ribbon, where the display order of the first segment and the second segment in the ribbon can be changed after the reassembly.

In response to the input rearranging the first segment and the second segment, the system can change (508) the sort hierarchy such that the data set is sorted on the first sort level by the second field and then on the second sort level by the first field. In some implementations, the system can provide for display a visible sort control (e.g., visible sort control 104) operable to receive an input of turning displaying the ribbon on or off.

### Exemplary System Architecture

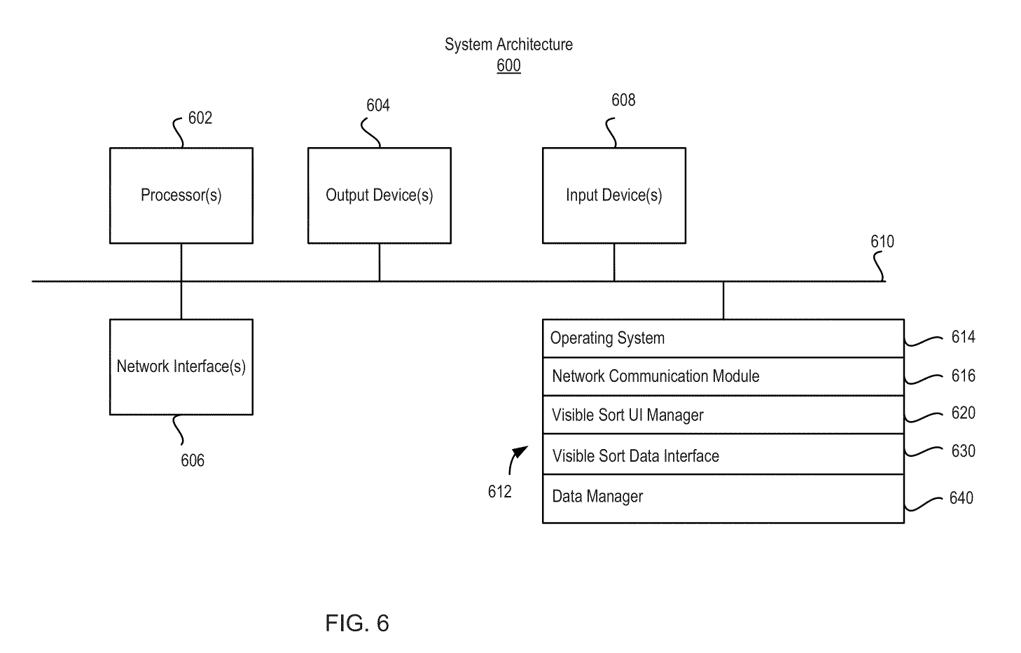

FIG. 6 is a block diagram of exemplary system architecture 600 for implementing the features and operations of FIGS. 1-5. Other architectures are possible, including architectures with more or fewer components. In some implementations, architecture 600 includes one or more processors 602 (e.g., dual-core Intel® Xeon® Processors), one or more output devices 604 (e.g., LCD), one or more network interfaces 606, one or more input devices 608 (e.g., mouse, keyboard, touch-sensitive display) and one or more computer-readable mediums 612 (e.g., RAM, ROM, SDRAM, hard disk, optical disk, flash memory, etc.). These components can exchange communications and data over one or more communication channels 610 (e.g., buses), which can utilize various hardware and software for facilitating the transfer of data and control signals between components.

The term “computer-readable medium” refers to a medium that participates in providing instructions to processor 602 for execution, including without limitation, non-volatile media (e.g., optical or magnetic disks), volatile media (e.g., memory) and transmission media. Transmission media includes, without limitation, coaxial cables, copper wire and fiber optics.

Computer-readable medium 612 can further include operating system 614 (e.g., a Linux® operating system), network communication module 616, visible sort user interface manager instructions 620, visible sort data interface instructions 630, and data manager instructions 640. Operating system 614 can be multi-user, multiprocessing, multitasking, multithreading, real time, etc. Operating system 614 performs basic tasks, including but not limited to: recognizing input from and providing output to devices 606, 608; keeping track and managing files and directories on computer-readable mediums 612 (e.g., memory or a storage device); controlling peripheral devices; and managing traffic on the one or more communication channels 610. Network communications module 616 includes various components for establishing and maintaining network connections (e.g., software for implementing communication protocols, such as TCP/IP, HTTP, etc.).

Visible sort user interface manager instructions 620 can include computer instructions that, when executed, cause processor 602 to perform operations described above in reference to visible sort user interface manager 402. Visible sort data interface instructions 630 can include computer instructions that, when executed, cause processor 602 to perform operations as described above in reference visible sort data interface 408. Data manager instructions 640 can include computer instructions that, when executed, cause processor 602 to perform operations as described above in reference to data manager 404.

Architecture 600 can be implemented in a parallel processing or peer-to-peer infrastructure or on a single device with one or more processors. Software can include multiple software components or can be a single body of code.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, a browser-based web application, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor or a retina display device for displaying information to the user. The computer can have a touch surface input device (e.g., a touch screen) or a keyboard and a pointing device such as a mouse or a trackball by which the user can provide input to the computer. The computer can have a voice input device for receiving voice commands from the user.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations of the invention have been described. Nevertheless, it will be understood that various modifications can be made without departing from the spirit and scope of the invention.

What is claimed is:

1. A method comprising:
providing for display a formatted view of a data set, the data set arranged to have a plurality of fields and a plurality of records and being presented based on a sort hierarchy specifying that the data set is sorted by a first field of the data set and then by a second field of the data set, the first field corresponding to a first sort level, the second field corresponding to a second sort level, wherein a priority of sorting the data set on the first sort level is higher than a priority of sorting the data set on the second sort level;
providing for display a user interface item representing the sort hierarchy, the user interface item having a plurality of segments, wherein a first segment corresponds to the first sort level and a second segment corresponds to the second sort level, wherein a display order of the first segment and the second segment in the user interface item indicates the sort hierarchy;
receiving an input rearranging the first segment and the second segment, including changing the display order of the first segment and the second segment in the user interface item; and
in response to the input, changing the sort hierarchy, including sorting the data set by the second field and then by the first field, the second field corresponding to the first sort level, the first field corresponding to a second sort level.

2. The method of claim 1, wherein the user interface item comprises a ribbon having a rectangular shape, and each segment of the ribbon has at least one wedged end that appears locked with another segment.

3. The method of claim 1, wherein the input comprises selecting one of the first segment or second segment in the user interface item, and dragging and dropping the selected segment at a new position in the user interface item.

4. The method of claim 1, wherein each of the first segment and second segment comprises an identifier of a corresponding field and an indicator of a sort order, the sort order being one of an ascending order, a descending order, or a custom order.

5. The method of claim 4, wherein the indicator of sort order comprises a series of bars each having a unique length, an arrangement of the bars indicating that the corresponding sort order is the ascending order, the descending order, or the custom order.

6. The method of claim 1, comprising:
receiving a select input on one of the first segment or second segment; and
in response to the select input, providing for display a user interface for changing a sort order of the corresponding field or removing the corresponding segment from the user interface item.

7. The method of claim 1, comprising providing for display a visible sort control operable to receive an input of turning displaying the user interface item on or off.

8. A system comprising:
one or more processors; and
a non-transitory storage medium storing instructions operable to cause the one or more processors to perform operations comprising:
providing for display a formatted view of a data set, the data set having a plurality of fields and a plurality of records and being presented based on a sort hierarchy specifying that the data set is sorted on by a first field of the data set and then by a second field of the data set, the first field corresponding to a first sort level, the second field corresponding to a second sort level, wherein a priority of sorting the data set on the first sort level is higher than a priority of sorting the data set on the second sort level;
providing for display a user interface item representing the sort hierarchy, the user interface item having a plurality of segments, wherein a first segment corresponds to the first sort level and a second segment corresponds to the second sort level, wherein a display order of the first segment and the second segment in the user interface item indicates the sort hierarchy;
receiving an input rearranging the first segment and the second segment, including changing the display order of the first segment and the second segment in the user interface item; and
in response to the input, changing the sort hierarchy, including sorting the data set by the second field and then by the first field, the second field corresponding to the first sort level, the first field corresponding to a second sort level.

9. The system of claim 8, wherein the user interface item comprises a ribbon having a rectangular shape, and each segment of the ribbon has at least one wedged end that appears locked with another segment.

10. The system of claim 8, wherein the input comprises selecting one of the first segment or second segment in the user interface item, and dragging and dropping the selected segment at a new position in the user interface item.

11. The system of claim 8, wherein each of the first segment and second segment comprises an identifier of a corresponding field and an indicator of a sort order, the sort order being one of an ascending order, a descending order, or a custom order.

12. The system of claim 11, wherein the indicator of sort order comprises a series of bars each having a unique length, an arrangement of the bars indicating that the corresponding sort order is the ascending order, the descending order, or the custom order.

13. The system of claim 8, the operations comprising:
receiving a select input on one of the first segment or second segment; and
in response to the select input, providing for display a user interface for changing a sort order of the corresponding field or removing the corresponding segment from the user interface item.

14. The system of claim 8, the operations comprising providing for display a visible sort control operable to receive an input of turning displaying the user interface item on or off.

15. A non-transitory storage medium storing computer instructions operable to cause one or more processors to perform operations comprising:
providing for display a formatted view of a data set, the data set having a plurality of fields and a plurality of records and being presented based on a sort hierarchy specifying that the data set is sorted on a first sort level by a first field of the data set and then on a second sort level by a second field of the data set;
providing for display a user interface item representing the sort hierarchy, the user interface item having a plurality of segments, wherein a first segment corresponds to the first sort level and a second segment corresponding to the second sort level, wherein a display order of the first segment and the second segment in the user interface item indicates the sort hierarchy;
receiving an input rearranging the first segment and the second segment, including changing the display order of the first segment and the second segment in the user interface item; and
in response to the input, changing the sort hierarchy, including sorting the data set by the second field and then by the first field, the second field corresponding to the first sort level, the first field corresponding to a second sort level.

16. The non-transitory storage medium of claim 15, wherein the user interface item comprises a ribbon having a rectangular shape, and each segment of the ribbon has at least one wedged end that appears locked with another segment.

17. The non-transitory storage medium of claim 15, wherein the input comprises selecting one of the first segment or second segment in the user interface item, and dragging and dropping the selected segment at a new position in the user interface item.

18. The non-transitory storage medium of claim 15, wherein each of the first segment and second segment comprises an identifier of a corresponding field and an indicator of a sort order, the sort order being one of an ascending order, a descending order, or a custom order.

19. The non-transitory storage medium of claim 18, wherein the indicator of sort order comprises a series of bars each having a unique length, an arrangement of the bars indicating that the corresponding sort order is the ascending order, the descending order, or the custom order.

20. The non-transitory storage medium of claim 15, the operations comprising:
receiving a select input on one of the first segment or second segment; and
in response to the select input, providing for display a user interface for changing a sort order of the corresponding field or removing the corresponding segment from the user interface item.

21. The non-transitory storage medium of claim 15, the operations comprising providing for display a visible sort control operable to receive an input of turning displaying the user interface item on or off.
